(19) United States
(12) Patent Application Publication
(10) Pub. No.: US 2013/0170200 A1
(43) Pub. Date: Jul. 4, 2013

(54) Light Source

(71) Applicant: Martin Moeck, Regensburg (DE)

(72) Inventor: Martin Moeck, Regensburg (DE)

(73) Assignee: OSRAM GmbH, Munich (DE)

(21) Appl. No.: 13/704,928

(22) PCT Filed: Jun. 3, 2011
(86) PCT No.: PCT/EP2011/059207

§ 371 Date: Mar. 14, 2013

(30) Foreign Application Priority Data
Jun. 16, 2010 (DE) 10 2010 023 956.9

(51) Int. Cl. F21V 9/00

(52) U.S. Cl. CPC F21V 9/00
USPC 362/231

(57) ABSTRACT

A light source comprising at least one illumination unit having a plurality of light-emitting diodes comprising a plurality of first light-emitting diodes and a plurality of second light-emitting diodes, wherein the first and second light-emitting diodes emit light having mutually different colors, and wherein the plurality of the light-emitting diodes are arranged along a bent curve.

A light source comprising light-emitting diodes (LEDs) is specified.

This patent application claims the priority of German patent application 10 2010 023 956.9, the disclosure content of which is hereby incorporated by reference.

Lighting devices comprising LEDs and in particular comprising an LED cluster having different-colored LEDs, for example blue, green and/or red LEDs, are nowadays usually arranged compactly, wherein the individual LEDs adjacent to one another have a specific distance, also designated as “pitch”, which cannot be undershot on account of structural and/or heat engineering reasons. Furthermore, the total number of LEDs is usually also limited with regard to a maximum operating temperature of the lighting device on account of the heat emitted by the LEDs during operation.

If, by way of example, a typical lighting device for generating white light having a color temperature of approximately 4000 K is assumed, this lighting device can comprise for example approximately 21 green or mint-green and approximately 5 red LEDs. The red LEDs are required in particular for increasing the so-called color rendering index (CRI). On account of the above standpoints with regard to the arrangement of LEDs and the small number of red LEDs in comparison with the green LEDs, the distance between the red LEDs is maximized in a cluster having red and green LEDs distributed as uniformly as possible.

If such a lighting device is used to illuminate an object, for instance a hand or a pencil, then an observer can clearly perceive, in the shadow cast by the object in the light from the lighting device, color inhomogeneities, so-called color shadows or color patterns, and luminance inhomogeneities, so-called luminance shadows or luminance patterns, which are brought about by the small number of red LEDs and their large distance with respect to one another within the LED cluster of the lighting device.

In order to minimize the color shadows and luminance shadows, significantly more LEDs would be required, but this is technically not possible, or possible only with high outlay, for the abovementioned reasons with regard to the evolution of heat in the lighting device.

It is shown in “The IESNA Lighting Handbook”, 9^{th} ed., 2000, Illumination Engineering Society of North America, New York, pages 3-18 and 3-19, that the spatial resolving power of the human eye after an observation time of 800 ms is approximately 0.6 arc minutes. Discrete differences in luminance must therefore have smaller spatial resolutions in order not to be perceived as disturbing by an observer.

A color and/or luminance shadow can be perceived as disturbing particularly in the case of work space lighting arrangements. In order to illustrate this, a shadow-casting object can be assumed to be, by way of example, a parallelepiped to be illuminated which is situated on a planar surface, for instance a table or a worktop, centrally at the origin of a spatial coordinate system (X, Y, Z) and has a spatial extent of 5 mm in each case in the X- and Y-directions and of 150 mm in the Z-direction, which corresponds to the height of the top side of the parallelepiped above the planar surface. Furthermore, a lighting device comprising one red and one green LED can be assumed, said LEDs being at a distance of 3 mm from one another, which is typical of conventional lighting devices, and said lighting device being fitted at a height of 1000 mm above the planar surface corresponding to a vertical spatial coordinate Z=1000 mm and at horizontal spatial coordinates X=500 mm and Y=500 mm. Simulations can show that besides a black umbra of the parallelepiped, a respective colored edge in the form of a color shadow having a width of 0.2 mm is perceptible on the planar surface, this being brought about by the red LED, on the one hand, and by the green LED, on the other hand. Furthermore, assuming an observer who observes the shadow from a distance of typically approximately 0.7 m, the width of the color shadow corresponds to a respective spatial resolution of approximately 1 arc minute, such that the color shadows are still clearly perceptible even from this distance. In the case of such a work space lighting arrangement, the maximum distance between the different-colored LEDs would thus have to be less than approximately 1.5 mm in order to avoid the otherwise clearly visible and discretely perceptible color fringes and luminance fringes, but this is usually not technically possible.

It can furthermore be shown that an additional use of a common reflector for the LEDs of a lighting device cannot avoid the colored shadows cast either, but rather leads to discrete regular, “rhythmic” color patterns.

Therefore, in the case of conventional lighting devices comprising LED clusters, use is usually made of optical films, for example diffusing films, which reduce the optical efficiency, however.

It is an object of at least one embodiment to specify a light source comprising light-emitting diodes which can at least reduce the disadvantages described above.

This object is achieved by means of an article comprising the features of the independent patent claim. Advantageous embodiments and developments of the article are characterized in the dependent claims and are furthermore evident from the following description and the drawings.

A light source in accordance with at least one embodiment of the invention comprises, in particular, at least one illumination unit having a plurality of light-emitting diodes, which has a plurality of first light-emitting diodes and a plurality of second light-emitting diodes. The first and second light-emitting diodes in each case emit light having mutually different colors. Furthermore, the plurality of the light-emitting diodes is arranged along a bent curve.

Here and hereinafter, a bent curve denotes a continuous, constant and uninterrupted curve which, at least conceptually, connects the light-emitting diodes (LEDs) to one another. Furthermore, the bent curve has no straight partial sections and no kinks. In other words, it is always the case that three LEDs—directly adjacent to one another—of the plurality of the LEDs are not arranged along a straight line. The bent curve, with regard to its basic form, can be selected, in particular, from a group formed by a circle, an ellipse, an arc of a circle, an arc of an ellipse, a spiral, a spline and combinations thereof. In this case spline denotes a curve having curve portions which are attached to one another continuously and without kinks and which can in each case be defined for example by polynomial functions, circular functions, elliptic functions and/or trigonometrical functions. A spline can therefore also be designated as a freeform curve which is, particularly in the mathematical sense, continuous and at least singly differentiable and therefore has no gaps or kinks. If the arrangement of the positions of the LEDs in the light source is defined as points in a coordinate system, then the bent curve represents, in particular, that curve which, under given boundary conditions, specifies the shortest curve which interconnects all points defined by the LEDs. The given boundary conditions can for example particularly preferably be selected from the basic form of the bent curve and, if appropriate, from the maximum polynomial degree of curve portions of a spline.

As in the case of conventional lighting devices, each of the plurality of LEDs, when illuminating an article, also gives rise to shadowing behind the article which corresponds to the color of said LED. However, the arrangement of the plurality of the LEDs along the bent curve in the case of the light source described here deviates from conventional arrangements of LEDs in matrix-like patterns having rows and columns, as a result of which, when illuminating the article, a superimposition of the different cast shadows of the first and second LEDs can advantageously be achieved, as a result of which the color shadows and luminance shadows discernible in the case of known lighting devices comprising different-colored LEDs can at least be reduced or are even no longer perceptible at all to an observer.

In other words, with the light source described here, perceptible colored shadows cast and in particular “rhythms” and regularities in the luminance and color of the shadows, that is to say color shadows and luminance shadows, in comparison with known lighting devices comprising a plurality of different-colored LEDs, can be minimized or even cancelled without the need, for example, to arrange an optical film such as, for instance, a diffusing film in the beam path of the light-emitting diodes. In particular, it may be possible that in an observer's perception the shadows can advantageously flow out and become blurred with regard to luminance and color variations and/or can fall below the resolving power of the human eye.

A first element and a second element, that is to say for instance a first LED and a second LED or else two first LEDs or two second LEDs, here and hereinafter, are directly adjacent to one another along the bent curve if no further first element and no further second element are arranged proceeding from the first element along the course of the bent curve as far as the second element. A first and second element are otherwise directly adjacent to one another if the distance between the first element and the second element is shorter than the distances between the first element and any further second element.

The above-explained effect of the light source described here that color shadows and luminance shadows can be reduced or completely prevented can be further fostered and intensified by at least one or more of the following embodiments.

Particularly preferably, the first and second LEDs can be arranged alternately along the curved line. In the plurality of the LEDs, in each case one first and one second light-emitting diode that are directly adjacent along the bent curve can form an illumination group. Consequently, the first and second LEDs can form a plurality of illumination groups. Further first and/or second LEDs can be arranged between the illumination groups. Each illumination group can have a respective arrangement direction defined from the first to the second light-emitting diode. Particularly advantageously, the respective arrangement directions of at least two illumination groups are different. In other words, at least two of the illumination groups are rotated relative to one another. Furthermore, a plurality of illumination groups or even all of the illumination groups can also be rotated relative to one another and thus have mutually different arrangement directions.

Furthermore, each of the illumination groups can have a distance between the first and second LEDs, wherein the respective distance differs in the case of at least two illumination groups, preferably in the case of a plurality of illumination groups and/or particularly preferably in the case of all of the illumination groups.

Furthermore, a distance between at least two first LEDs that are directly adjacent to one another along the bent curve can differ from a distance between at least two second LEDs that are directly adjacent to one another along the bent curve. Additionally or alternatively, in the case of at least three first and/or second LEDs that are directly adjacent to one another along the bent curve, the two distances between the respective two directly adjacent LEDs can differ. In other words, a first and/or a second LED can have different distances with respect to two first and/or second LEDs, respectively, that are directly adjacent along the bent curve in different directions.

Preferably, a plurality of first and/or second LEDs or, particularly preferably, all of the first and/or second LEDs can have the different distances mentioned above. Furthermore, the light source can comprise a plurality of illumination units. Each of the plurality of the illumination units, that is to say of the at least two illumination units, can comprise one or more of the features mentioned above. In particular, the illumination units can differ from one another, for example with regard to the bent curves in respect of their size, length and/or form and/or with regard to the arrangement directions and/or the above-defined distances of at least two or preferably a plurality of illumination groups of different illumination units. In particular, at least two of the plurality of the illumination units, in the manner described above, can have in each case a plurality of light-emitting diodes arranged on a respective bent curve and the bent curves can differ from one another. Alternatively or additionally, an illumination group of one illumination unit and an illumination group—directly adjacent thereto—of another illumination unit can have different arrangement directions. This holds true preferably for a plurality or particularly preferably for all of the illumination groups of the illumination units.

Particularly preferably, in the case of a plurality of illumination units, the respective bent curves are defined in such a way that they do not overlap. By way of example, the bent curves of the plurality of the illumination units can be circles, ellipses or arcs thereof which are arranged one in another. Furthermore, the bent curves can also be arranged alongside one another. Furthermore, the bent curves can also be mutually rotated circles, ellipses, arcs of circles, arcs of ellipses or spirals, wherein the bent curves can be in each case identical or else different with regard to their form.

Furthermore, the plurality of LEDs can additionally comprise a plurality of third LEDs, which emits light having a different color than the first and second LEDs. By way of example, a plurality of illumination groups having a first and a second LED can additionally comprise a third LED. Particularly preferably, each of the illumination groups can comprise a first, a second and a third LED.

With regard to the arrangement and/or the distances of the third LEDs in relation to first and/or second and/or further third LEDs, the statements made above with regard to the first and second LEDs hold true. In this case, an illumination group can have a first arrangement direction from the first to the second LED and a second arrangement direction from the second to the third LED, wherein the statements made above with regard to the arrangement direction in each case hold true for the first and second arrangement directions.

The LEDs of the plurality of the LEDs can be embodied for example as LED chips in the form of semiconductor layer sequences based on arsenide, phosphide and/or nitride compound semiconductor material systems or else as corresponding LED chips in a housing, wherein for example each of the plurality of the LEDs can be arranged in a dedicated housing. By way of example, a first and a second LED and/or, if appropriate, a third LED can also be arranged in a common housing. Furthermore, one or more LEDs can also have a potting and/or one or more dyes for wavelength conversion in order to achieve a desired color locus and a desired color temperature of the emitted light. Such LEDs and modifications thereof are known to the person skilled in the art and will not be explained in any further detail here.

The plurality of the LEDs of one illumination unit or else of a plurality of illumination units can be arranged and electrically interconnected on a common carrier, for example a circuit board, and/or on a common heat sink. A carrier for an illumination unit can be shaped for example in the form of the bent curve.

The LEDs of the plurality of LEDs can emit light having a constant intensity or, as an alternative thereto, in each case emit light having varying intensities during operation. The respective emission directions of the light emitted by each of the plurality of the LEDs can be identical or else different. Furthermore, the LEDs of the plurality of LEDs can have one or more lenses and/or one or more reflectors by means of which the respective emission characteristic of the LEDs can be set. Furthermore, by way of example, a common carrier can also have a reflector and/or one or more lenses disposed downstream of the plurality of LEDs in the emission direction.

In particular, the plurality of the LEDs can emit white light, which can be particularly suitable for lighting purposes. For this purpose, the first LEDs can emit blue light, for example, and the second LEDs yellow light. Furthermore, the first LEDs can for example also emit white light and the second LEDs colored light, for example red light, for setting the color temperature of the light emitted by the light source. If the light source comprises a plurality of first, second and third LEDs, then the latter can respectively preferably emit green, blue and red light. By means of a relative change in the brightnesses of the first, second and, if appropriate, third LEDs with respect to one another, the color, brightness and color temperature of the light emitted by the light source can be settable.

In one particularly preferred embodiment, the light source comprises at least two illumination units having in each case a plurality of first and second light-emitting diodes which are arranged in each case on a bent curve in the form of an ellipse or a circle, wherein the bent curves are arranged one in another and have a common mid point, and wherein at least one first light-emitting diode of one of the at least two illumination units and a first light-emitting diode—directly adjacent thereto—of a second of the at least two illumination units with the mid point are not arranged on a straight line. Furthermore, the illumination units and/or the plurality of the LEDs can comprise one or more of the features above.

By means of the different arrangement directions described and also the different distances within an illumination unit and also the arrangement of a plurality of illumination units, that is to say at least two thereof, it is advantageously possible to achieve a maximum degree of irregularity in the arrangement of the first and second and, if appropriate, also of the third LEDs, as a result of which color shadows and/or luminance shadows can be reduced or completely prevented. In comparison with conventional lighting devices, which often comprise a large number of LEDs of one color and in addition a small number of even further LEDs of another color, in order to generate the desired mixed light, a comparatively larger number of differently colored LEDs can be used in the case of the light source described here.

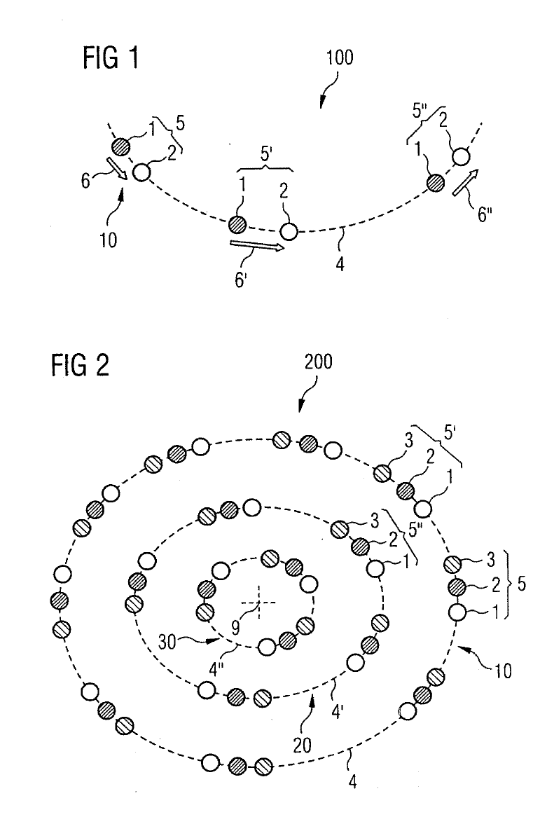

Further advantages and advantageous embodiments and developments of the invention will become apparent from the embodiments described below in conjunction with FIGS. 1 and 2.

In the figures:

FIG. 1 shows a schematic illustration of a light source in accordance with one exemplary embodiment, and

FIG. 2 shows a schematic illustration of a light source in accordance with a further exemplary embodiment.

In the exemplary embodiments and figures, identical or identically acting constituent parts may in each case be provided with the same reference signs. The illustrated elements and their size relationships among one another should not be regarded as true to scale, in principle; rather individual elements such as, for example, layers, structural parts, components and regions may be illustrated with exaggerated thickness or size dimensions in order to enable better illustration and/or in order to afford a better understanding.

FIG. 1 shows one exemplary embodiment of a light source 100 comprising an illumination unit 10. The illumination unit 10 comprises a plurality of light-emitting diodes (LEDs), which has a plurality of first LEDs 1 and a plurality of second LEDs 2, wherein the first LEDs 1 emit light having a different color than the second LEDs 2. By way of example, the first LEDs 1 emit blue light and the second LEDs 2 emit yellow light, such that the superimposition of the blue and yellow light produces white light emitted by the light source 100.

The plurality of the LEDs, that is to say the plurality of the first and second LEDs 1, 2, is arranged along a bent curve 4, which is embodied as an arc of an ellipse purely by way of example in the exemplary embodiment shown. As an alternative thereto, the bent curve can also be embodied as a circle, ellipse, arc of a circle, spiral, spline or combination thereof, as described in the general part.

The first and second LEDs 1, 2 are arranged alternately along the bent curve 4, wherein in each case one first LED 1 and one second LED 2 directly adjacent thereto along the bent curve 4 form an illumination group 5, 5′, 5″. Even further LEDs, for example first and/or second LEDs 1, 2 or LEDs that differ therefrom can additionally be arranged between the illumination groups 5, 5′, 5″.

Each illumination group 5, 5′, 5″ has a respective arrangement direction 6, 6′, 6″ pointing from the respective first LED 1 to the respective second LED 2. The arrangement directions 6, 6′, 6″ and thus the illumination groups 5, 5′, 5″ are rotated relative to one another.

Furthermore, the illumination groups 5, 5′, 5″ have mutually different distances. In particular, the first and second LEDs 1 also have in each case different distances relative to the respective first and second LEDs that are directly adjacent along the bent curve 4. Furthermore, a distance between at least two first light-emitting diodes 1 that are directly adjacent along the bent curve 4 also differs from a distance between at least two directly adjacent second light-emitting diodes 2.

As a result of the arrangement shown along the bent curve 4, the first and second LEDs 1, 2 thus have a high degree of irregularity, as a result of which, when an object is illuminated by the light source 100, color shadows and luminance shadows can be reduced in comparison with conventional lighting devices comprising different-colored LEDs.

The light source 100 furthermore comprises a common carrier (not shown) for the first and second LEDs 1, 2, which are embodied as semiconductor chips. The carrier comprises a circuit board shaped in accordance with the bent curve 4.

FIG. 2 shows a further exemplary embodiment of a light source 200, which, in comparison with the previous exemplary embodiment, comprises a plurality of third LEDs 3 in addition to the first and second LEDs 1, 2, only some of the LEDs 1, 2, 3 being provided with reference signs for the sake of clarity. Each illumination group 5, 5′, 5″ is assigned a first LED 1, a second LED 2 and a third LED 3.

The third LEDs emit different light than the first and second LEDs 1, 2. In the exemplary embodiment shown, the first LEDs 1 emit blue light, the second LEDs 2 green light and the third LEDs 3 red light, such that the light source 200 emits white light. The intensity respectively emitted by the first, second and third LEDs 1, 2, 3 can be settable in this case such that the color temperature and the color locus of the light emitted by the light source 200 can thereby be selectable.

In the exemplary embodiment shown, the light source 200 comprises three illumination units 10, 20, 30 respectively having the plurality of LEDs, that is to say the plurality of the first, second and third LEDs 1, 2, 3. Each plurality of LEDs of the illumination units 10, 20, 30 is arranged on a respective bent curve 4, 4′, 4″ in the form of an ellipse. As an alternative thereto, one or a plurality or all of the bent curves can for example also be circles or closed splines.

Each of the illumination units 10, 20, 30 has a circuit board running along the respective bent curve 4, 4′, 4″, on which circuit boards the first, second and third LEDs 1, 2, 3 are in each case mounted and interconnected with one another.

The bent curves 4, 4′, 4″ are arranged one in another and have a common mid point 9, wherein at least one first light-emitting diode 1 of the illumination group 5′ of the illumination unit 10 and a first light-emitting diode 1—directly adjacent thereto—of the illumination group 5″ of the illumination unit 20 with the mid point 9 are not arranged on a straight line. In particular, in the exemplary embodiment shown, no first LEDs 1, no second LEDs 2 and no third LEDs 3 with respective identical LEDs 1, 2, 3 directly adjacent thereto with the mid point 9 are arranged on a straight line, and so the illumination groups of the illumination units 10, 20, 30 are rotated or displaced relative to one another about the mid point 9. As a result, each of the illumination groups of one of the illumination units 10, 20, 30 and the illumination group—respectively directly adjacent thereto—of another of the illumination units 10, 20, 30 have different arrangement directions.

Furthermore, in addition the respective distances between illumination groups that are directly adjacent along the respective bent curve 4, 4′, 4″ also vary, such that the illumination units 10, 20, 30 are also rotated non-uniformly relative to one another with regard to the individual illumination groups. The distances between the first LEDs 1 and the second LEDs 2 and between the second LEDs 2 and the third LEDs 3 are in each case always approximately identical for the illumination groups in the exemplary embodiment shown. As an alternative thereto, the respective distances can also differ and be varied irregularly from illumination group to illumination group.

As a result of the arrangement of the plurality of the LEDs 1, 2, 3 along the bent curves 4, 4′, 4″, when an object is illuminated with the light source 200, a superimposition and in particular a swirling of the color shadows is brought about, which was able to be shown by simulations of an illumination incident obliquely on a parallelepiped having an edge length of 300 mm in each case, by means of the light source 200 described here. This leads to shadows flowing out and soft color profiles in the shadows, wherein discrete color shadows as in the case of conventional lighting devices comprising different-colored LEDs having clearly distinguishable color locus coordinates, the so-called CIE x-y coordinates, are avoided. In particular, the color differences that occur conventionally are minimized by the swirling in the case of the light source 200, such that no regularity and no rhythm occurs in the luminance and/or color of the shadows.

Alternatively or additionally, the light sources 100, 200 can also comprise further features of the embodiments described in the general part.

The invention is not restricted to the exemplary embodiments by the description on the basis of said exemplary embodiments. Rather, the invention encompasses any novel feature and also any combination of features, which in particular includes any combination of features in the patent claims, even if this feature or this combination itself is not explicitly specified in the patent claims or exemplary embodiments.

1.-15. (canceled)

16. A light source comprising:
at least one illumination unit having a plurality of light-emitting diodes comprising a plurality of first light-emitting diodes and a plurality of second light-emitting diodes,
wherein the first and second light-emitting diodes emit light having mutually different colors, and
wherein the plurality of the light-emitting diodes are arranged along a bent curve.

17. The light source according to claim 16, wherein the bent curve is selected from a group consisting of a circle, an ellipse, an arc of a circle, an arc of an ellipse, a spiral, a spline and combinations thereof.

18. The light source according to claim 16, wherein in each case one first and one second light-emitting diode that are directly adjacent along the bent curve form an illumination group having a respective arrangement direction from the first to the second light-emitting diode, and wherein the respective arrangement directions of at least two illumination groups are different.

19. The light source according to claim 18, wherein at least two illumination groups have distances between the respective first and second light-emitting diodes which are different.

20. The light source according to claim 16, wherein a distance between at least two first light-emitting diodes that are directly adjacent along the bent curve is different than a distance between at least two directly adjacent second light-emitting diodes.

21. The light source according to claim 16, wherein the distances between at least three first light-emitting diodes that are directly adjacent to one another along the bent curve are different in each case.

22. The light source according to claim 16, wherein the distances between at least three second light-emitting diodes that are directly adjacent to one another along the bent curve are different in each case.

23. The light source according to claim 16, comprising a plurality of illumination units that differ from one another.

24. The light source according to claim 23, wherein the illumination units in each case have a plurality of light-emitting diodes arranged along a respective bent curve and the bent curves differ from one another.

25. The light source according to claim 23, wherein the bent curves of the plurality of the illumination units do not overlap.

26. The light source according to claim 23, wherein at least one illumination group of one illumination unit and an illumination group—directly adjacent thereto—of another illumination unit have different arrangement directions.

27. The light source according to claim 16, wherein the plurality of light-emitting diodes furthermore has a plurality of third light-emitting diodes, which emits light having a different color than the first and second light-emitting diodes.

28. The light source according to claim 16, wherein each of the illumination groups has a first, a second and a third light-emitting diode.

29. The light source according to claim 16, wherein the plurality of the light-emitting diodes of the at least one illumination unit emits white light.

30. The light source according to claim 16, comprising at least two illumination units having in each case a plurality of first and second light-emitting diodes which are arranged in each case on a bent curve in the form of an ellipse or a circle, wherein the bent curves are arranged one in another and have a common mid point, and wherein at least one first light-emitting diode of one of the at least two illumination units and a first light-emitting diode—directly adjacent thereto—of a second of the at least two illumination units with the mid point are not arranged on a straight line.

31. A light source comprising:
at least one illumination unit having a plurality of light-emitting diodes comprising a plurality of first light-emitting diodes and a plurality of second light-emitting diodes,
wherein the first and second light-emitting diodes emit light having mutually different colors,
wherein the plurality of the light-emitting diodes are arranged along a bent curve,
wherein in each case one first and one second light-emitting diode that are directly adjacent along the bent curve form an illumination group having a respective arrangement direction from the first to the second light-emitting diode,
wherein the respective arrangement directions of at least two illumination groups are different, and
wherein at least two illumination groups have distances between the respective first and second light-emitting diodes which are different.

32. A light source comprising:
a plurality of illumination units,
wherein each of the illumination units has a plurality of light-emitting diodes comprising a plurality of first light-emitting diodes and a plurality of second light-emitting diodes,
wherein the first and second light-emitting diodes emit light having mutually different colors,
wherein the plurality of the light-emitting diodes are arranged along a bent curve,
wherein the plurality of illumination units differ from one another, and
wherein the bent curves of the plurality of the illumination units do not overlap.
